(19) United States
(12) Patent Application Publication
(10) Pub. No.: US 2012/0024221 A1
(43) Pub. Date: Feb. 2, 2012

(54) SIGNAL AND MARKER TOOL

(76) Inventor: Steven R. Clothier, Sherwood, WI (US)

(21) Appl. No.: 13/187,028

(22) Filed: Jul. 20, 2011

Related U.S. Application Data
(62) Division of application No. 12/484,469, filed on Jun. 15, 2009.

(51) Int. Cl. G08B 7/00

(52) U.S. Cl. 116/3

(57) ABSTRACT

A marking and signaling tool may include one or more lights and a sound generating device within a housing. A protective sheath may be positioned about the housing and permit light and/or sound to exit from the housing. An actuator may be provided to permit a user to select one of a plurality of illumination modes. One or more of the illumination modes may include the creation of sound. The housing may include a plurality of magnets for adhering the tool to a magnetic surface.

### CROSS-REFERENCE TO RELATED APPLICATION

The present application is a divisional application of U.S. patent application Ser. No. 12/484469, filed on Oct. 9, 2008, the disclosure of which is incorporated herein by reference. The present application claims priority to U.S. Provisional Patent Application Ser. No. 60/978,449, filed on Oct. 9, 2007, the disclosure of which is incorporated herein by reference.

### BACKGROUND

Today's law enforcement officer faces many challenges. Keeping society safe is the number one priority of a police officer; safe from criminals, safe from weapons, safe from drugs. The job description of a police officer is extensive and varies from traffic stops to foot pursuits to cats in trees. Some of the most highly stressful and challenging events can be hardest on officers.

When engaged in such an event, it is desirable that the officer be provided with flexible tools with which to accomplish different tasks. It is further desirable that tools be adaptable to as many tasks as possible to reduce the load of material or tools that an officer needs to carry. At the same time, it is desirable that the adaptation of the tool to different jobs should not result in an undesirable compromise with regard to the ability of the tool to perform the task. It is also foreseeable that such law enforcement origin tools that might be useful for a police officer may be useful and desirable to other civilian users and that such a tool may be adapted for civilian use.

Improvements to existing tools for police officers and civilians are desirable.

### BRIEF DESCRIPTION OF THE DRAWINGS

The accompanying drawing figures, which are incorporated in and constitute a part of the description, illustrate several aspects of the invention and together with the description, serve to explain the principles of the invention. A brief description of the figures is as follows:

FIG. 1 is a front perspective view of an embodiment of a signal and marker tool according to the present disclosure.

FIG. 2 is a rear perspective view of the tool of FIG. 1.

FIG. 3 is a rear perspective view of a second embodiment of a signal and marker tool according to the present disclosure.

FIG. 4 is a front perspective view of a third embodiment of a signal and marker tool according to the present disclosure with a provision for mounting the tool to a belt.

FIG. 5 is a front perspective view of a second embodiment of a belt mounting provision for the tool of FIG. 4.

FIG. 6 is a front perspective view of a third embodiment of a signal and marker tool according to the present disclosure.

FIG. 7 is a front view of the tool of FIG. 6.

FIG. 8 is a rear view of the tool of FIG. 6.

FIG. 9 is a front view of the tool of FIG. 6 with an outer boot removed.

FIG. 10 is a front perspective view of the outer boot of the tool of FIG. 6.

FIG. 11 is a front view of the tool of FIG. 7 with a front portion of the housing removed.

FIG. 12 is a front view of an assembly of internal components of the tool of FIG. 6 with the housing removed.

FIG. 13 is a rear view of the assembly of internal components of FIG. 12.

### DETAILED DESCRIPTION

A signal and marker tool as described herein was created to help alleviate some situational stress and save valuable time. Even with the vast amount of training, officers are not immune to the adrenaline rush and hyper-arousal of senses that can occur while trying to apprehend a suspect. During a pursuit, officers rely on their skills and expertise, but can become distracted due to the intensity of the chase. Law enforcement officers can use the marker capabilities of the tool described herein to identify where a fleeing suspect has dropped evidence (i.e. paraphernalia, weapons, etc.). Such a marker may then assist officers in easily recovering evidence simply by marking its location. The evidence marker can reduce stress; more efficiently locate evidence, and, in turn save valuable time and manpower plus remove potentially harmful items from the public.

A signal and marker tool as described may be a small, lightweight, reflective device that an officer carries or attaches to their equipment belt or is located in their vehicle. The tool is preferably highly visible and easy to find both day and night. The tool may also be printed with a cautionary label indicating that it is law enforcement property and that removal or tampering with the marker may result in criminal penalties.

A simplest version of a tool according to the present disclosure might be a soft durable bag with a reflective outer covering or reflective attachments to the outer covering. Such a marker bag would preferably be brightly colored for daytime visibility and reflective to aid in nighttime recovery. A marker may have luminescent material included in or on the outer covering to aid in nighttime recovery. Photo-luminescent may be included which provide a passive location aid after dark. Chemical luminescent features may be included that are in capsules designed to rupture and mix when thrown, similar to chemical glowsticks. A suitable marker may include a covering stuffed with beads or other non-rebounding material, so that the marker does not bounce or roll far from its original location when thrown. The covering might be a fabric material that incorporates reflective materials or may have reflective materials applied to an outer surface. Alternatively, the marker may be made entirely of a suitable non-rebounding material with appropriate outer surface characteristics.

A further passive location enhancement might be the inclusion of scent producing or dispensing features in the marker. Scents may be used to alert officers or police dogs to the presence and location of markers previously thrown. Markers could include scent materials in sealed capsules designed to break when the marker hits the ground, similar to the chemical luminescent materials described above. Alternatively, the marker could include a scent pad impregnated with a particular scent chosen to stand out from possible background smells. A scent pad might be sealed while the marker is attached to the officer's gear or vehicle but released when the marker is removed from the mounting, ensuring that the scent is sufficiently strong to support later location of the marker.

The following are ideas to make the evidence marker a more viable and superior product through the use of technology. The term “personal marker” used on the following pages, refers to a marker that a law enforcement officer may wear on his or her belt or have otherwise attached to part of the officer's uniform. The marker may typically be used during foot pursuits to identify objects or points of interest at a crime scene or accident. The term “vehicle marker” refers to a marker that may be stored in an officer's vehicle and accessible to one or more occupants of the vehicle. This marker may typically be used during vehicle pursuits to identify evidence discarded by a suspect.

Option #1

Personal Marker w/Strap:

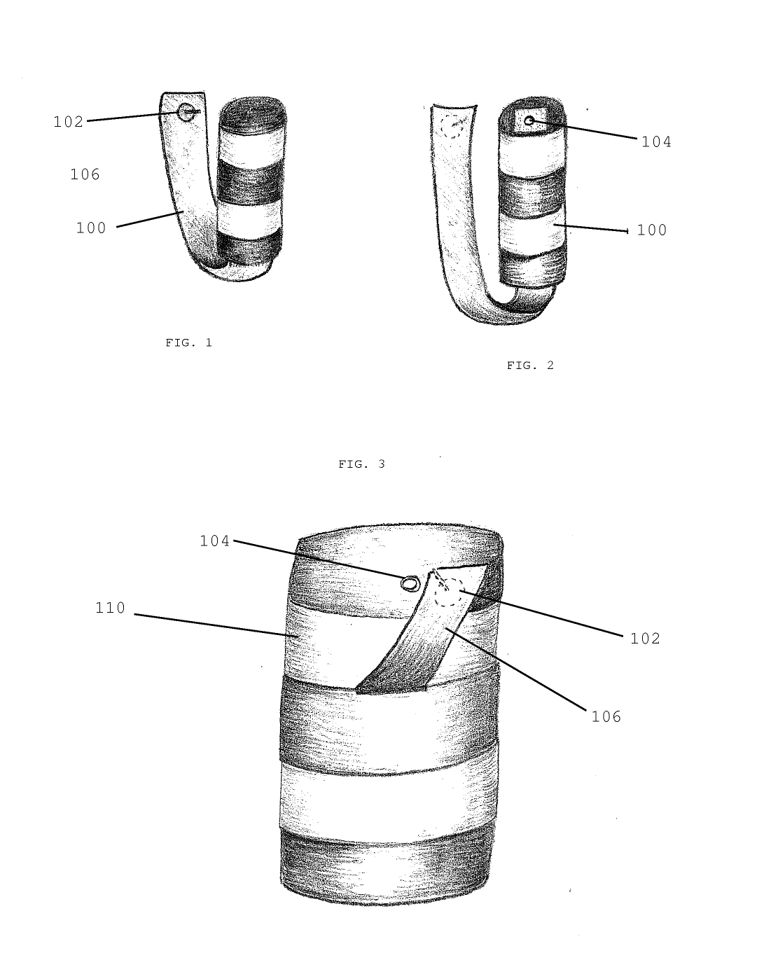

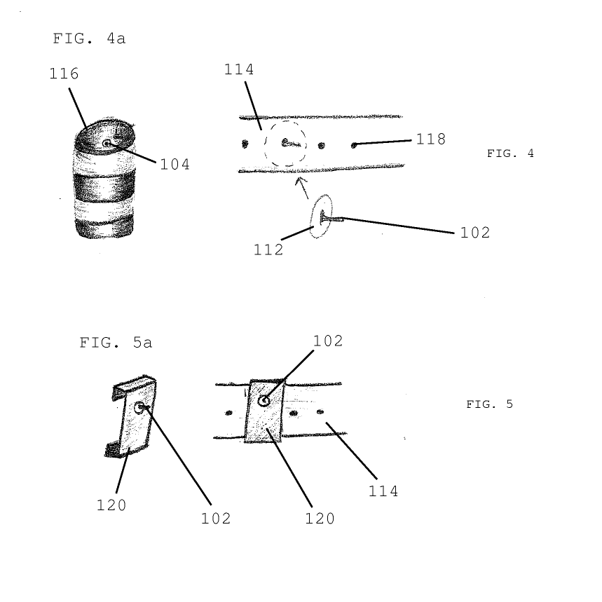

As shown in FIGS. 1 and 2, this first embodiment of a marking tool 100 according to the present disclosure is equipped with an LED lighting system as well as an audible signal that would activate after a pin 102 is removed from a socket 104. Pin 102 (male attachment) can be attached to the end of a strap 106 incorporating a releasable closure such as a hook and loop arrangement that keeps the evidence marker on the officer's belt. When the officer detaches marker 100 from the belt, pin 102 is removed from socket 104, thus activating the light and tonal response. Marker 100 would continue to be “hot” until an officer finds it and reconnects the pin. The marker could be used again as long as it is found before the batteries expire.

Vehicle Marker w/Strap:

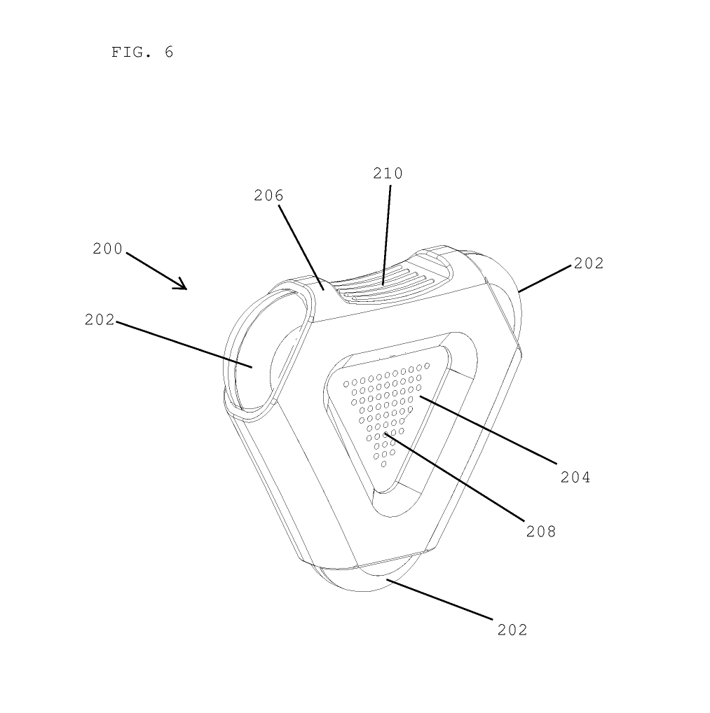

As shown in FIG. 3, an alternative embodiment of a vehicle marking tool 110 according to the present invention may include circuitry and activation similar to marker 100 described above. Marker 110 may be securely attached within the vehicle such as in the officer's storage area under the driver's arm rest, or fastened on the dash board for easy access. When grabbed and pulled pin 102 would disengage from socket 104 and activate visual and/or audible signals of marker 110 immediately. Similarly to a more personal sized marker 100, vehicle sized marker 110 would continue to signal until pin 102 is inserted back into socket 104 of marker 110.

Option #2

Personal Marker with Male/Female Attachment:

Several different alternatives are contemplated for mounting the personal marker described above to the uniform of an officer. These alternatives are illustrative only and are not intended to limit the scope of the present disclosure.

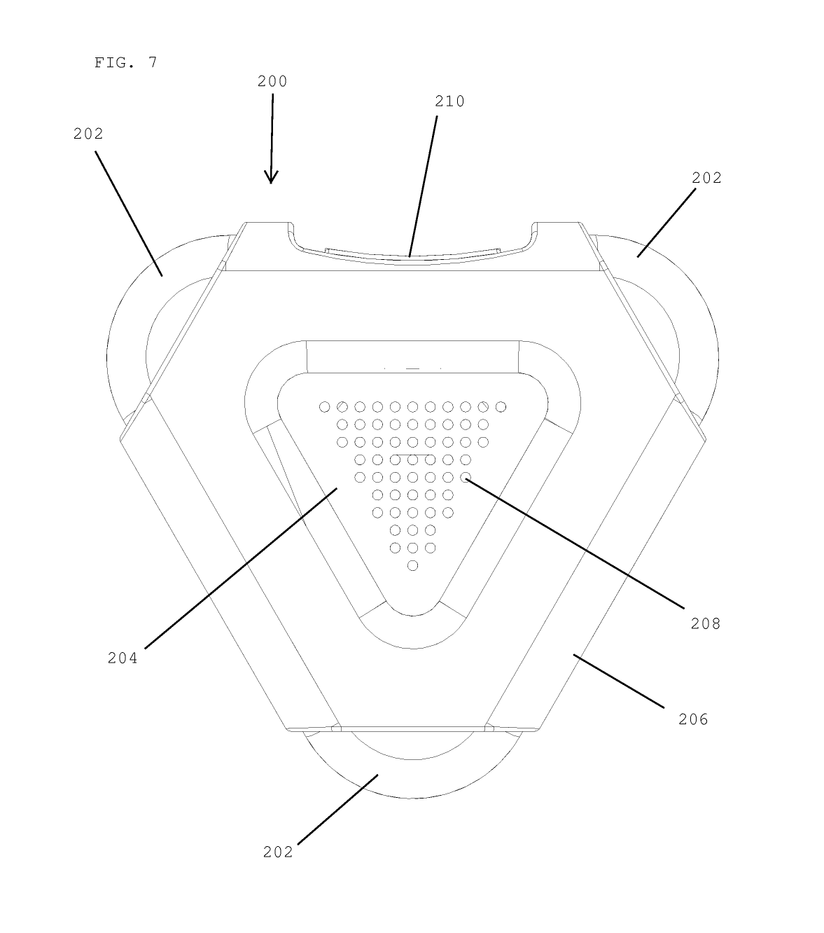

A. An adhesive disk 112 would stick through one of the extra holes 118 in an officer's belt 114. A marker 116 might then attach securely to the male piece or pin 102 sticking through belt 114 and engage a socket 104. This is illustrated in FIGS. 4 and 4a.

B. As shown in FIGS. 5 and 5a, an aluminum/steel clip 120 would slide over belt 114 and allow the officer to place the marker anywhere on belt 114.

This alternative personal marker 116 eliminates the strap as described in option #1, above, but otherwise the two markers 100 and 116 may be similarly configured with the signaling features (flashing/beeping) essentially the same. Once the marker is removed from the belt, it remains “hot” or active until it is picked up and placed back on the belt or the batteries expire.

Vehicle Marker with Male/Female Attachment:

It is anticipated that an alternative embodiment of a vehicle marker according to the present disclosure may be configured with a male/female mounting arrangement as described above. However, it is also anticipated that such a vehicle marker might require a more robust version of such a mounting arrangement. It is anticipated that the vehicle marker might be more substantially weighted and might be subject to more severe forces based on the movement of the vehicle during a chase or other rough driving conditions. Such greater weight and greater force may require that the male/female mounting arrangement be substantially beefed up to handle the greater stress.

Option #3

Personal Marker w/Universal Remote:

A further embodiment of a personal evidence marker according to the present disclosure might be attached either with the strap method or the male/female attachment as described above. Alternatively, any suitable mounting may be used within the scope of the present disclosure. Upon activation, the alerting lights and audible signal might continue for a specified period of time, such as for example approximately 20 minutes. The marker could then be configured to go inactive after the specified time period and remain in this inactive state until an officer approaches to within a certain distance of the marker and activates a remote control device. For example, the officer might be supplied with a radio transmitter that is capable of sending a signal to a bag within 100 yards of the officer actuating the transmitter. Alternatively, officers might each be provided with a key fob that includes a universal transmitter. Such a universal transmitter might send a continuous ping or signal when activated so that one or more officers may be involved in searching for a previously placed marker. Any of the involved officers' remote might activate any “hot” evidence marker when the officer passes within the range of the transmitter from the marker. This would also allow investigators investigating a crime scene where multiple markers may be placed by activating a universal remote to locate all marked areas of interest at the scene.

Vehicle marker w/Universal Remote:

Similar to personal marker with universal remote described above.

Option #4

Personal Marker w/Proximity Chip:

This alternative embodiment of a marker according to the present disclosure would attach to the officer's belt by the strap method or with the male/female attachment as described above. This option may be the best if it is a cost effective application. A chip or other electronic circuitry would be attached to both the officer's belt as well as inside the evidence marker. The marker circuitry would cause the marker to begin signaling when it is a certain specified distance, such as for example, 5 feet or more, away from the corresponding circuitry located on the officer. The marker would continue to flash/beep until an officer with a corresponding circuitry is within a certain specified distance, such as for example 5 feet, of the marker, thus canceling the alerting reaction. A particular marker might be keyed or associated with a particular circuit carried by an officer. Alternatively, the marker and the officer circuits may be universal in nature and any officer's circuitry can deactivate any bag when the officer is within the specified distance.

This concept may even be viable for parents to monitor and keep track of their children in busy shopping malls, grocery stores, amusement parks, swimming pools, etc.

Vehicle Marker w/Proximity Chip:

Similar to the personal marker with proximity chip, described above, but with a chip or other circuitry attached or mounted at the vehicle marker storage point. The distances involved with such a vehicle marker embodiment might be varied from the distances for activation and deactivation that were described above, to take into account the ability of a vehicle to reach all areas where the marker may have been placed. Alternatively, individual officers may be equipped with a corresponding circuit that might deactivate the marker signaling apparatus when the officer is within the specified distance from the marker. This would facilitate markers thrown or placed from a vehicle to be located and identified by officers on foot later.

It is also anticipated that a vehicle marker embodiment may be configured to begin signaling immediately upon being used to mark possible evidence. Such a marker might continue to actively signal for a fixed period of time, for example but limited to twenty minutes, and then go into a stand-by mode. Any vehicle or officer with an appropriate coordinated signaling device or circuit coming within range of the marker in stand-by mode would trigger the marker to being actively signaling again, so that the searching officers are able to locate the marker and the associated potential evidence. Such a live signaling/stand-by mode of operation may be incorporated into a personal marker as well.

While the various embodiments and alternatives described above have been illustrated with markers having a bag like shape, it is not intended that markers according to the present disclosure be limited to bag-type markers. Other suitable, low-bounce alternatives to bean-bag type markers are anticipated to be adaptable to the present disclosure. It is desirable that a marker according to the present disclosure be constructed so as to not travel far from the location where it is thrown or placed. Bean bags or other soft shapes filled with impact absorbing materials such as beads or other suitable materials are within the present disclosure.

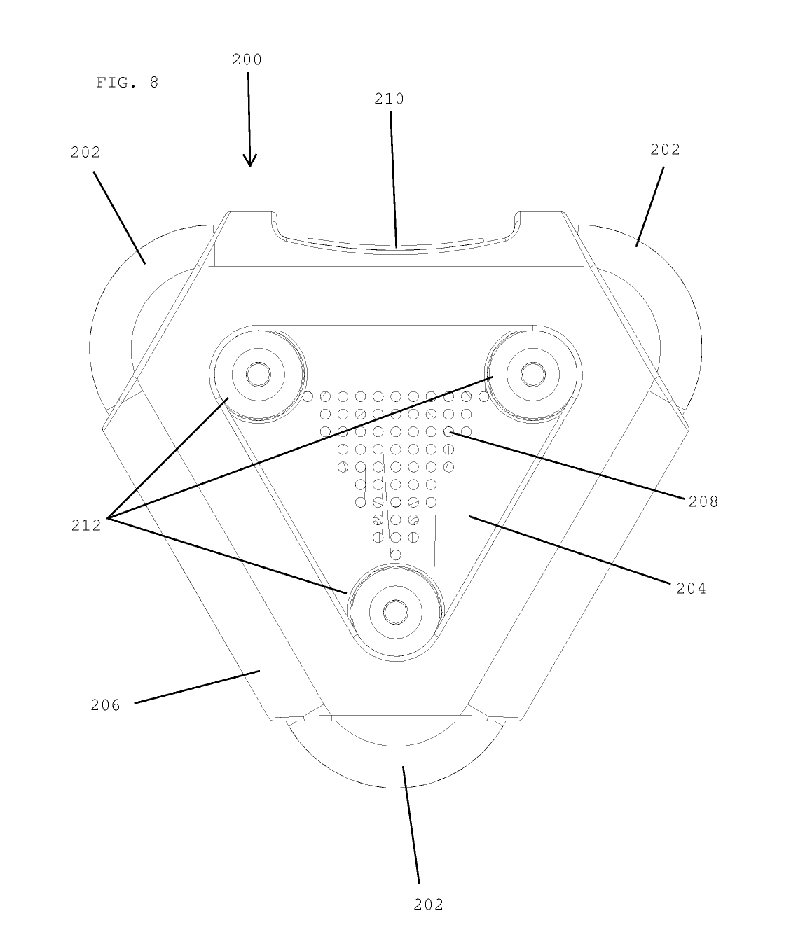

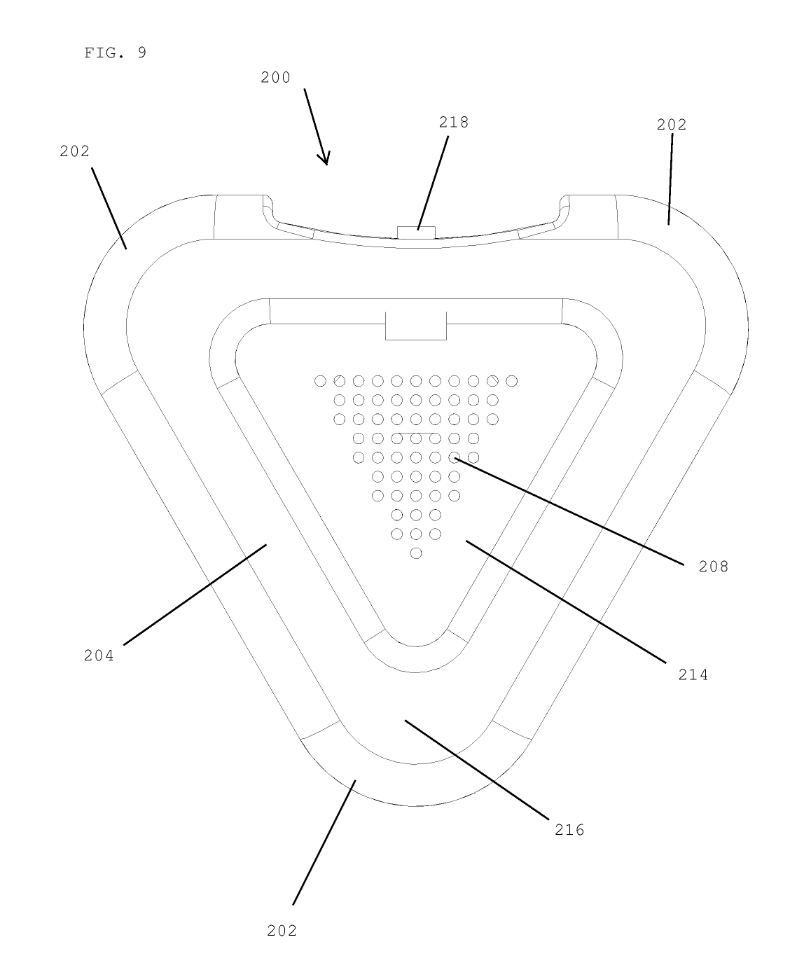

Referring now to FIGS. 6 and 7, a signal and marking tool 200 is shown. Tool 200 is shown as triangular in layout but other geometric designs of regular or irregular shapes may be used to facilitate gripping and handling of the tool. As shown, tool 200 includes a lamp 202 located at each of the vertices of the triangular shape. Tool 200 may be configured with a main housing 204 with an overlaying protective boot or sheathing 206. Sheath 206 may be configured to provide abrasion resistance or shock resistance when tool 200 is dropped or thrown to assist in the location of a lost, discarded or hidden object. Housing 204 as shown contains the various electrical components of tool 200 in a secure, durable and weather-resistant fashion.

Some discontinuities such as perforations 208 may be provided to allow sound generated by tool 200 to exit housing 204 more easily. As an alternative to the embodiments illustrated above, where retrieving the tool or marker from a holding position activated some or all of the active signals generated by the tool or marker, tool 200 may include a user activated switch 210 along one portion of housing 204. As shown, switch 210 is positioned beneath a recessed portion of sheath 206 to provide additional protection to the switch against accidental actuation. As tool 200 incorporates some additional operational modes as will be described below, it is of interest that switch 210 allows a user to select a desired operational mode before deploying the tool and also to not have the desired mode accidentally altered by inadvertent actuation of switch 210.

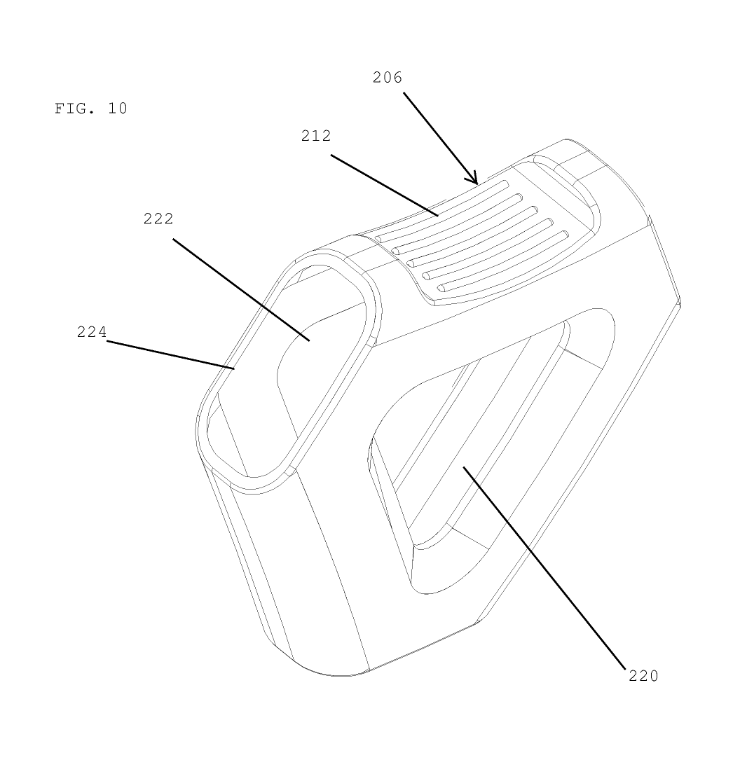

Referring now to FIG. 8, tool 200 may include one or a plurality of magnets 212 extending through a rear of housing 204 and accessible through sheath 206. Magnets 212 may assist the user in placing the tool in a particular location for the purpose of marking or locating an object. It is anticipated that magnets 212 may be strong enough to permit attachment of the tool to a car or truck. Such magnets may also permit tool 200 to be placed on a metal cabinet or housing to mark a location or to permit a trail to be indicated as a user passes along a route that he/she wishes to retrace or that others might follow.

FIG. 9 illustrates tool 200 with sheath 206 removed to expose the front of housing 204. Perforations 208 may be positioned on a recessed inner portion 214 of a front housing half 216. A switch actuator 218 may be positioned on a side of housing 204 where it would be located beneath switch 212 of sheath 206. With sheath 206 or portions of the sheath made of a resilient deformable material such as might be useful to protect tool 200 from abuse or shocks of normal use, sheath 206 may be pressed downward to engage actuator 218. Depressions or sequences of depressions may serve to activate different modes of operation of the tool, as will be discussed below.

As can be seen in FIG. 9, lamps 202 may be formed integrally with housing 204 or may be elements added to and sandwiched between other elements or housing portions that make up housing 204. Sheath 206 is illustrated as being positioned to allow unobstructed viewing of lamps 202. It is anticipated that other shapes, geometric figures and designs may be used for housing 204 and that lamps 202 may be positioned anywhere along an exterior of such a shape with sheath 206 configured to not obscure or obstruct any of the lamps. Lamps could be positioned intermediately along the sides or front or rear of housing 204 with sheath 206 appropriately adapted to permit visibility of these lamps.

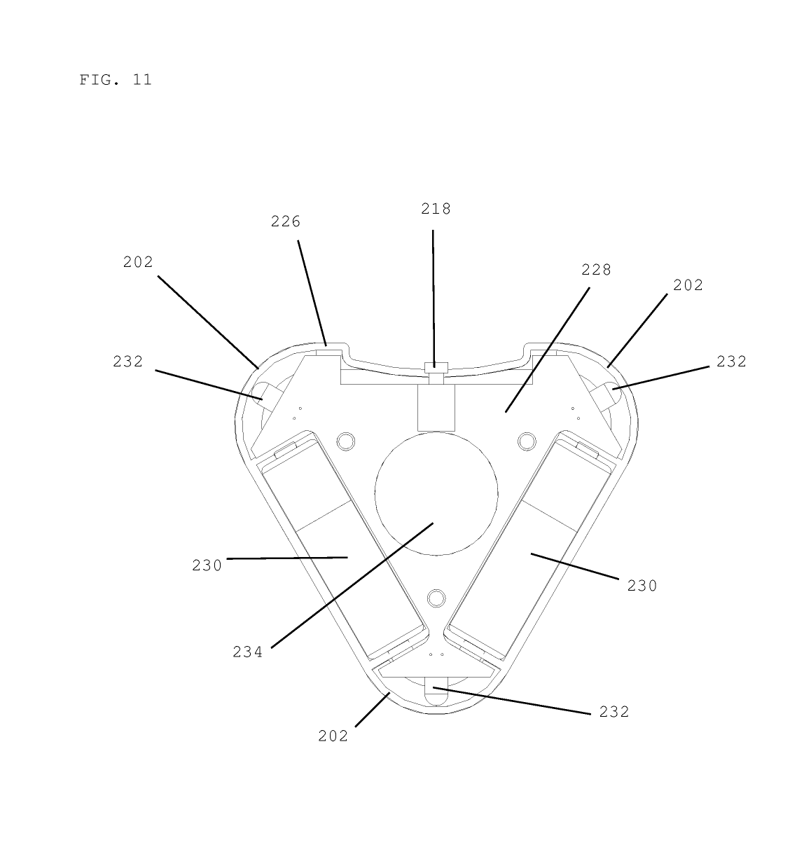

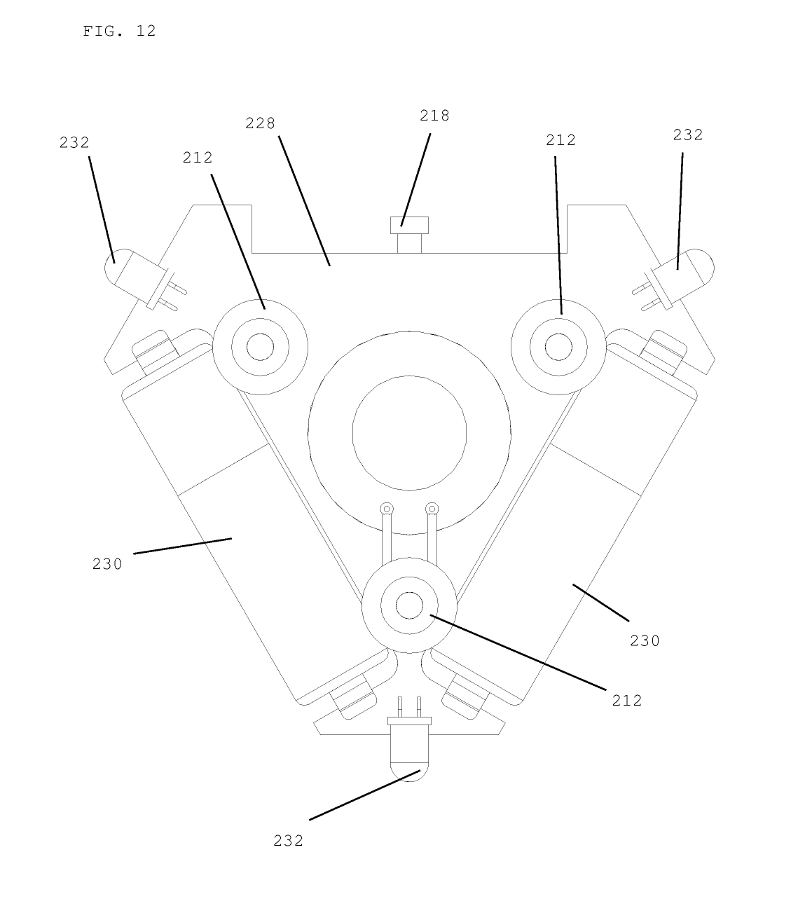

Referring now to FIG. 10, sheath 206 includes a plurality of peripheral openings 224 to permit visibility of lamps 202 when the sheath is positioned about housing 204. A front opening 220 provides visibility and access to recessed inner portion 214 of front housing 216. A rear opening 222 provides access to magnets 212 and perforation 208 on a rear housing 226 (shown in FIG. 11 below). Since it is desirable that magnets 212 be positioned and sized to permit tool 200 to be adhered magnetically to a surface, sheath 206 adjacent opening 222 is preferable thin and or magnets 212 extend beyond an outer surface of rear housing 226. Sheath 206 adjacent opening 220 may be the same thickness as the sheath adjacent rear opening 222 or it may be thicker to provide additional cushioning and protection to housing 204. The openings 222 and 224 may be the same size or may be sized differently to provide a visual indication of the orientation in which sheath 206 should be installed on housing 204.

FIG. 11 illustrates rear housing 226 with front housing 216 removed, showing some interior components of tool 200. A circuit board 228 may be included with circuitry to accomplish the different actuation and operation of lights or other location or identification means built into the device. A pair of batteries 230 may be included to provide power for operation of the device. Individual lights 232 such as LEDs may be positioned adjacent lamps 202 in rear housing 226 and front housing 216. The lights may be mounted to circuit board 228 along with actuator 218 with associated circuitry and possibly logic components to enable different modes of operation of tool 200. A sound generating element such as speaker 234 may be centrally positioned on circuit board 228 and located adjacent to perforations 208 in both front housing 216 and rear housing 226.

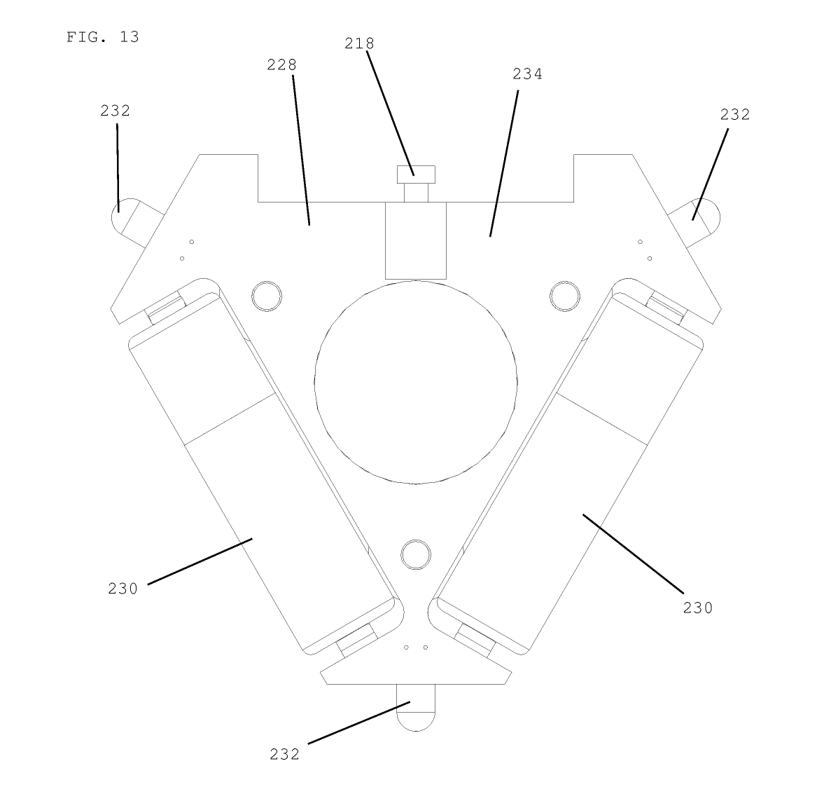

FIG. 12 illustrates a rear side of circuit board 228 with rear housing 226 removed. Magnets 212 may be mounted to circuit board 228 as well and protrude above the circuit board for extension through rear housing 226. Magnets 212 may be electrically connected to circuit board 228 as well. This will permit the circuitry on board 228 to be configured to react to being magnetically attached to some object so that a certain sequence of lights or sounds are emitted when tool 200 is attached to a metallic object. Front and rear housings 216 and 226 may be releasably mounted to each other and to circuit board 228 to permit easy access to and replacement of batteries 230 or lights 232 as needed. There may be switches incorporated into circuit board 228 that would permit setting tool 200 to operate in one of several selectable modes (e.g. a marker mode or an emergency signal mode, but not limited to just these two modes).

FIG. 13 illustrates a front side of circuit board 228 with rear housing 226 removed.

Alternatively, front and rear housings 216 and 226 may be generally permanently sealed to each other to ensure a weather-tight fit between them to protect the internal components of tool 200. Instead of having replaceable batteries 230, the batteries may have plug-in or inductive battery charging capability. Lights 232 may be LEDs with an operational life expected to meet or exceed the life expectancy or mean time before failure of the overall tool 200.

While tool 200 is shown with a single light 232 at each corner or associated with each lamp, it is anticipated that one or all of the lamps 202 may have one or more lights associated with them. Additional lights 232 at one of the lamps 202 may permit a low battery indicator condition to be signaled. To accomplish this battery indicator function, the lamp associated with this function may be a lower powered or less-bright LED so that the low battery indication is clearly distinguishable from other modes of signal. In addition, it is anticipated to lights 232 at each corner may be all the same color or that the color of one or more of the lights differs from the others. Different sequences of color flashing from such varied lights may be used to indicate operation of different functions of tool 200. Further, more lights 232 such as LEDs might be used at one or more lamps to increase the brightness of the signal possible by that lamp.

As a non-limiting example of multiple lights and modes of operation, one possible embodiment might have red, white and blue LEDs installed at each lamp. Selection of multiple modes of operation of these LEDs may be accomplished by sequence pressing of switch 212 and actuator 218. Tool 200 may be is a neutral or standby mode as a default. A first press of switch 212 might place tool 200 into a Hot mode, where all nine LEDs flash in sequence and are accompanied by an audible alarm. A second press of switch 212 may activate a sequence of flashing of single or lesser combinations of the LEDs without an alarm. Third press may bring all nine LEDs into flash mode without an audible alarm. A fourth press may bring all nine LEDs into a steady light mode. A fifth press or a press and hold of at least two seconds at anytime during operation of tool 200 may result in tool 200 going back to neutral or standby mode.

Examples of when the different modes may be desirable include when selecting the first, second or third mode when placing the tool on a suspect's car during a traffic stop to aid in identification and location of the car when or if the driver attempts to flee from police. The tool could be placed in the Hot mode and attached to a suspect's handcuffs when an officer is dealing with multiple issues. If the suspect wearing the handcuffs tries to flee, the lights and alarm will allow officers to quickly track them down. An officer or security person may wish to have tool 200 in a signal or alert mode to be placed on the back side of a squad car or other vehicle attending to an incident. In this flash or signal mode, the officer may also place tool 200 on his/her person to make the officer stand out from the background or a confused scene.

In addition, by having one or more of the lights on steady, tool 200 may be used as an auxiliary or temporary lighting device in place of a flashlight. By having a neutral mode without a second master or power switch, tool 200 can be in condition for immediate use and activation without a power up time lag but at the same time will be in a standby mode drawing little power until actually needed. This will permit quick activation of the tool while also conserving battery life.

In a flash mode, tool 200 may be placed along a roadway or other location to serve as a warning flasher to others approaching a scene. Investigation of a crime or crash scene in low light conditions can be facilitated by having several devices in the same operational mode placed at the beginning and end of skid marks, or used to indicate where evidence, bodies, shell casings, etc, were found as the scene is reviewed by officers. In a situation where a number of widely dispersed officers are operating in an area, one officer may activate his tool 200 in a particular mode to permit other officers to quickly locate and approach his/her position. An officer who has apprehended a suspect and needs help in securing the arrest or who has been injured or come across an injured person may use the tool to signal a location and direct others to that location.

When a K-9 squad is working and the dog is allowed to move away from the handler, a tool 200 in a particular mode of flash may be attached to the dog's collar to permit officers to track and locate the dog and anything the dog may have discovered. In a darkened scene where an emergency vehicle such as an ambulance or helicopter is needed, a tool 200 may be placed as a marker for the vehicle to approach and permit the officers to continue with other duties.

While the above discussion has primarily been directed for use by police or security personnel, it is also anticipated that tool 200 may be useful to other emergency response personnel such as fire, rescue, first responder, or hazardous material teams. Prison guards or prisoner transport teams may make use of tools such as described herein to aid their operations as well as aiding in the location and recovery of escapees. Other civilian uses by hikers, motorists, road construction crews, truckers, vehicle towers, etc, may also make use of tools according to the present disclosure in a manner similar to those described above.

Much of the above discussion has been directed to a device that is directly or internally actuated to a particular mode of signal or flashing. However, a tool according to the present disclosure can also be paired with a mating fob. When the tool is moved away from the fob, and the tool has been separated by a minimum distance, the tool will begin flashing or signaling in a set fashion. Different proximities or distance from the fob may result in different modes of flash or signaling. Alternatively, the mode of flash or signal may be selected remotely by signal from a fob, where the tool is placed at a specific location and the fob is used to initiate a mode of flash at a later time.

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention.

What is claimed is:

1. A method of marking a location of evidence by a police officer during a pursuit, the method comprising:
providing a marking device releasably mounted to a mounting arrangement, the marking device including electrical circuitry and elements within a housing with at least one signal mode and a standby mode, the marking device maintained in the standby mode while mounted to the mounting arrangement, the marking device further including a housing configured to resist movement when the marking device is placed to mark a location;
the police officer identifying the evidence to be marked during the pursuit;
the police officer releasing the marking device from the mounting arrangement, wherein releasing the marking device activates one of the signal modes of the marking device;
the police officer placing the marking device adjacent the location of the evidence and continuing the pursuit;
the police officer returning to the location of the evidence after concluding the pursuit and locating the evidence based on the signal mode of the marking device.

2. The method of claim 1, wherein the marking device includes a soft deformable housing about the electrical circuitry and elements and deformation of the housing aids the marking device in resisting movement from adjacent the location of the evidence.

3. The method of claim 2, wherein the soft deformable housing is a bean bag.

4. The method of claim 1, wherein the housing of the marking device includes a shape that resists movement when the marking device is placed adjacent the location of the evidence.

5. The method of claim 4, wherein the housing of the marking device is generally triangular in shape with a generally flat profile, and includes lights mounted adjacent the vertices of the triangular shape.

6. The method of claim 5, wherein the marking device further includes a protective sheath positioned about at least a portion of the housing and permitting visibility of the lights.

7. The method of claim 1, wherein the marking device includes a plurality of lights that are illuminated when the signal modes of the marking device are activated.

8. The method of claim 1, wherein the marking device includes a sound generating device and sound is generated by the marking device when at least one of the signal modes is activated.
